(19) United States
(12) Patent Application Publication
(10) Pub. No.: US 2006/0184944 A1
(43) Pub. Date: Aug. 17, 2006

(54) Scheduling batch jobs

(76) Inventor: Uwe Schwerk, Heidelberg (DE)

Correspondence Address: FISH & RICHARDSON, P.C., PO BOX 1022, MINNEAPOLIS, MN, 55440-1022, US

(21) Appl. No.: 11/056,478

(22) Filed: Feb. 11, 2005

(51) Int. Cl. G06F 9/46

(52) U.S. Cl. 718/101

(57) ABSTRACT

A technique is described in which a plurality of requests for batch jobs is received. Each batch job corresponds to one of a plurality of batch job categories. Each batch job category has one or more associated time slots. Each request includes a selection of one or more of these associated time slots. Thereafter, each batch job is processed during one or more of the selected time slots.

### TECHNICAL FIELD

The subject matter described herein relates to data processing, for example, scheduling batch jobs.

### BACKGROUND

A batch job is a computer program or set of programs processed in batch mode. During batch mode, a sequence of commands for execution by an operating system is listed in a file (often called a batch file, command file, or shell script) and is submitted for execution as a single unit. A batch job typically involves reading data from a database, processing the data, and then returning the processed data to the database. The execution of batch jobs maybe automated or manually initiated. Often, batch jobs are executed after business hours when system usage is lower to minimize impact to users.

Batch jobs may be scheduled according to a variety of criteria including factors such as the date of the batch job request, amount of time and/or processing resources required to execute the request, business requirements, system resources, downtimes, and the like. As a result, batch jobs start times are typically scheduled by administrators using a scheduler taking into account such factors. With such arrangements, end users requiring batch processing (e.g., printing business documents overnight) must place a request with an administrator to schedule the processing of a particular batch job.

### SUMMARY

In one aspect, scheduling batch jobs involves receiving a plurality of requests for batch jobs in which each batch job corresponds to one of a plurality of batch job categories. Each batch job category has one or more associated time slots and each request includes a selection of one or more of the associated time slots. Each batch job is processed during one or more of the selected time slots.

The batch jobs may pertain to a wide variety of applications such as: financial management reports, marketing reports, supply chain management reports, inventory reports, invoice reports, customer account processing, automated system backup, automated data backup, system performance reporting, and the like.

Scheduling batch jobs may further comprise defining the plurality of batch job categories. Optionally or in addition, the method may comprise assigning one or more time slots for each of the plurality of batch job categories. The time slots may be recurring or they may be identified based on system parameters such as processing consumption levels.

In some variations, a load on a system is monitored during one or more of the time slots. The monitored load may be used to provide historical data useful for scheduling batch jobs during certain time slots. In one variation, the processing processes each batch job during one or more of the selected time slots in which the load on the system is below a predetermined threshold.

The method may also include authenticating the requests. The authentication may be used to verify that requests are originating from authorized network nodes and/or individuals on these network nodes.

Batch job processing may be prioritized such that higher priority batch jobs are processed prior to batch jobs with lower conflicting priority batch jobs. For example, a system back up batch job may take priority over a weekly newsletter broadcast email scheduled for the same time slot. Other criteria may be taken into account when prioritizing conflicting batch job requests.

In another inter-related variation, a method may comprise receiving an inquiry to initiate a batch job associated with one of a plurality of batch job categories, presenting a plurality of available time slots in which the batch job can be processed, each of the plurality of available time slots being associated with the one of a plurality of batch job categories, selecting one or more time slots from the plurality of available time slots, and generating a request to initiate the batch job during at least one of the one or more selected time slots. Such a method may optionally also include receiving the request, and processing the batch job during one or more of the selected time slots.

In one aspect, an apparatus includes a receiver to receive a plurality of requests for batch jobs, each batch job corresponding to one of a plurality of batch job categories, each batch job category having one or more associated time slots, each request including a selection of one or more of the associated time slots, and a processor to process each batch job during one or more of the selected time slots.

In another aspect, an apparatus comprises a reception unit to receive an inquiry to initiate a batch job associated with one of a plurality of batch job categories, a presentation unit to present a plurality of available time slots in which the batch job can be processed, each of the plurality of available time slots being associated with the one of a plurality of batch job categories, a selection unit to select one or more of the plurality of available time slots, and a generation unit to generate a request to initiate the batch job within one of the selected time slots.

Computer program products, which may be embodied on computer readable-material, are also described. Such computer program products may include executable instructions that cause a computer system to conduct one or more of the method acts described herein.

Similarly, computer systems are also described that may include a processor and a memory coupled to the processor. The memory may encode one or more programs that cause the processor to perform one or more of the method acts described herein.

The subject matter described herein may provide one or more of the following advantages. The techniques and systems described herein allow an end-user with limited knowledge of system resources to schedule a batch job within certain limitations. In connection therewith, an administrator may define special batch jobs that represent batch job categories (e.g., one batch job per batch job category). In addition, in some variations, the administrator may schedule the batch jobs at various times (e.g., the time slots associated with the batch job category). Therefore, in some variations, once these time slots have been established, no interaction between an end-user and an administrator is required to process the batch job (i.e., the administrator does not need to approve and/or assign a time for each batch job request).

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a first process flow diagram useful for understanding and implementing the subject matter described herein;

FIG. 2 is a second process flow diagram useful for understanding and implementing the subject matter described herein;

FIG. 3 is a schematic of a first apparatus useful for understanding and implementing the subject matter described herein;

FIG. 4 is a schematic of a second apparatus useful for understanding and implementing the subject matter described herein; and

FIG. 5 is a block diagram of a plurality of clients interfacing with a scheduler over a network that is useful for understanding and implementing the subject matter described herein.

Like reference symbols in the various drawings indicate like elements.

### DETAILED DESCRIPTION

The following describes aspects related both to the generation of a request for batch job processing and to the processing of a request for batch job processing. It will be appreciated that these aspects may be practiced singly or in combination depending on the desired configuration.

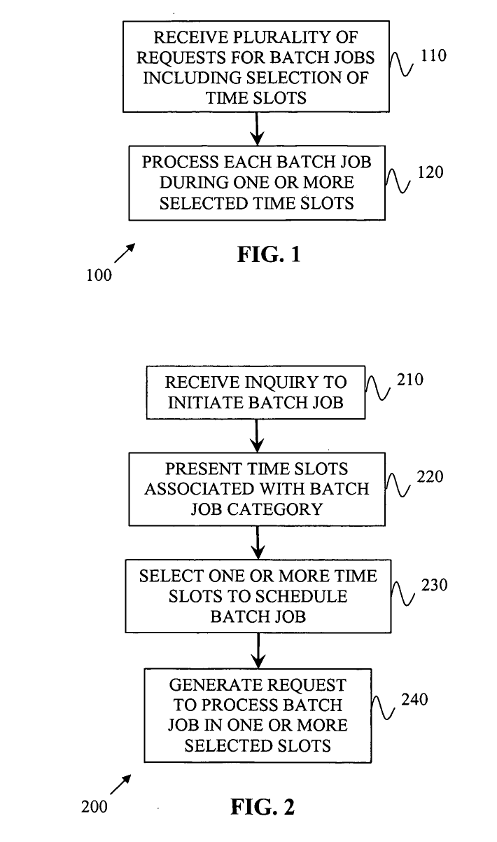

FIG. 1 illustrates a method 100 that may include, at step 110, receiving a plurality of requests for batch jobs. Each such batch job may correspond to one of a plurality of batch job categories. The batch job categories in turn may each have one or more associated time slots. The request may indicate in which of one or more of the associated time slots processing is desired. At step 120, the method may process each batch job during one or more of the selected time slots.

The batch job categories define certain types of batch jobs. The categories may be defined by a system administrator based on any criteria that may be used to differentiate batch job types. In some variations of the subject, the administrator may define special batch jobs that represent the batch job categories (e.g., one batch job per category). In addition, the administrator may schedule these special batch jobs at different times (e.g., time slots associated with the batch job category). For example, batch jobs that require lengthy processing might be associated with one batch job category so that they may be processed during off-hours. Batch jobs that require short processing might be placed into another batch job category so that they may be processed during short intervals during peak usage hours.

Each batch job category has one or more time slots assigned to it. The time slots may be recurring or they may be triggered based on processing consumption. For example, a time slot may be 1:15 am to 1:23 am every day. Alternatively, a time slot may be defined as any time during a predefined period in which processing consumption is below a certain level. During these time slots, batch jobs such as message broadcasting, printing requests, web site log analyses, and the like may occur. In some variations, a user may first select a batch job category when generating a batch job request. In other variations, a batch job category is assigned after the actions to be taken by a batch job are specified by a user.

Load on the system may be monitored continually and/or during the time slots. The load monitoring data can be used to make determinations on when to assign time slots and which batch jobs requests to handle/process within a particular requested time slot. For example, if a batch job request selects three time slots, the historical load data may be known for each of these slots. Therefore, a determination may be made taking into account average load when determining when to process the corresponding batch job (i.e., the batch job may be processed during the time slot with the lowest historical load).

Measures may be incorporated to ensure that received batch job requests are from authorized users. Passwords, IP address authentication, and similar techniques may be used to confirm the identify of a node or component issuing a request.

If numerous requests are received for the same time slots, the requests may be processed according to a priority ranking. The requests may be assigned priority designations based on criteria such as origination of requests, category of request (in case multiple request categories utilize overlapping time slots), load levels, and the like.

FIG. 2 illustrates a method 200 that may include, at step 210, receiving an inquiry to initiate a batch job associated with one of a plurality of batch job categories. At step 220, a plurality of available time slots in which the batch job can be processed may be presented. The batch job category corresponding to the batch job includes a plurality of available time slots in which batch jobs of this type may be processed. The method may also include, at step 230, selecting one or more of the available time slots and/or, at step 240, generating a request to initiate the batch job within one of the selected time slots. The actions illustrated in FIG. 2 may be practiced singly or in combination with those described in connection with FIG. 1.

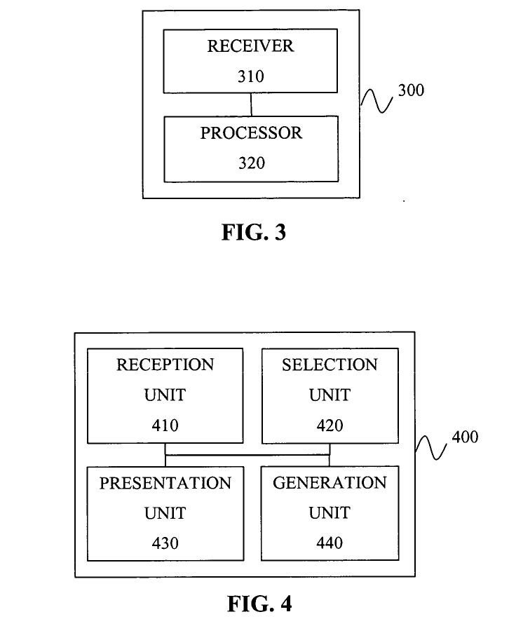

FIG. 3 illustrates an apparatus 300 that may include a receiver 310 and a processor 320. The receiver 310 may receive a plurality of requests for batch jobs. The batch jobs may each fall within one a plurality of batch job categories. Each of the batch job categories may have one or more time slots in which corresponding batch jobs may be processed. Each received request may also include a selection (which may be made, for example, by the originator of the request) of one or more of the time slots associated with the batch job categories. A processor 320 may process each batch job during the one or more of the selected time slots. Optionally, a scheduler (not shown) may be interposed between the receiver 310 and the processor 320 which schedules the processing to be conducted by the processor 320. Otherwise, the processor 320 may handle the scheduling of the batch jobs.

FIG. 4 illustrates an apparatus 400 that may include a reception unit 410, a presentation unit 420, a selection unit 430, and a generation unit 440. The reception unit 410 may receive an inquiry to initiate a batch job associated with one of a plurality of batch job categories. The presentation unit 420 may present a plurality of available time slots in which the batch job can be processed. This presentation may be visual in the form of a graphical user interface or it may be presented through non-graphical means. Each of the plurality of available time slots may be associated with the batch job category. The section unit 430 may select one or more of the plurality of available time slots. The generation unit 440 may generate a request to initiate the batch job within one of the selected time slots.

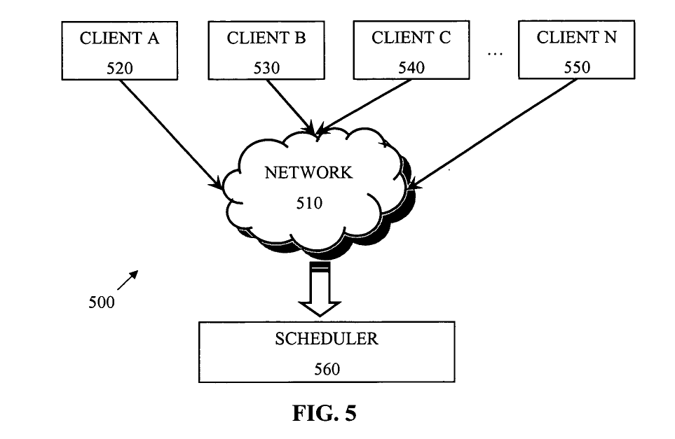

FIG. 5 illustrates a block diagram 500 in which a plurality of clients 520, 530, 540, 550 are coupled to a scheduler 560 via a network 510. Each of the clients 520, 530, 540, 550 may generate a batch job request including the selection of time slots associated with a batch job category which is sent via the network 510 to the scheduler 560. The scheduler 560 may schedule each batch job within one or more of the selected time slots. The scheduler 560 may in turn be coupled to other network nodes or components which may process or otherwise handle the scheduled batch jobs.

Various implementations of the systems and techniques described herein may be realized in digital electronic circuitry, integrated circuitry, specially designed ASICs (application specific integrated circuits), computer hardware, firmware, software, and/or combinations thereof. The various implementations may include one or more computer programs that are executable and/or interpretable on a programmable system including at least one programmable processor, which may be special or general purpose, coupled to receive data and instructions from, and to transmit data and instructions to, a storage system, at least one input device, and at least one output device.

The computer programs (also known as programs, software, software applications or code) may include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the systems and techniques described here), or any combination of such back-end, middleware, or front end components. The components of the system may be interconnected by any form or medium of digital data communication (e.g., a communication network). Examples of communication networks include a local area network (“LAN”), a wide area network (“WAN”), an intranet, the Internet, and wireless networks, such as a wireless WAN.

The computing system may include clients and servers. A client and server are generally remote from each other and typically interact through a communication network. The relationship of client and server arises by virtue of computer programs running on the respective computers and having a client-server relationship to each other.

A number of variations of the subject matter described herein have been described. Nevertheless, it will be understood that various modifications may be made without departing from the scope of the subject matter described herein. Accordingly, other variation are within the scope of the following claims.

What is claimed is:

1. A method comprising:
receiving a plurality of requests for batch jobs, each batch job corresponding to one of a plurality of batch job categories, each batch job category having one or more associated time slots, each request including a selection of one or more of the associated time slots; and
processing each batch job during one or more selected time slots.

2. A method as in claim 1, further comprising defining the plurality of batch job categories.

3. A method as in claim 1, further comprising assigning one or more time slots for each of the plurality of batch job categories.

4. A method as in claim 1, wherein the time slots are recurring.

5. A method as in claim 1, further comprising monitoring load on a system during one or more of the time slots.

6. A method as in claim 5, wherein the processing processes each batch job during one or more of the selected time slots in which the load on the system is below a predetermined threshold.

7. A method as in claim 1, further comprising authenticating the plurality of requests.

8. A method as in claim 1, further comprising prioritizing the batch jobs according to predetermined criteria.

9. A method comprising:
receiving an inquiry to initiate a batch job associated with one of a plurality of batch job categories;
presenting a plurality of available time slots in which the batch job can be processed, each of the plurality of available time slots being associated with the one of a plurality of batch job categories;
selecting one or more time slots from the plurality of available time slots for the batch job; and
generating a request to initiate the batch job during at least one of the selected one or more time slots.

10. A method as in claim 9, further comprising:
receiving the request; and
processing the batch job during at least one of the selected one or more time slots.

11. A method as in claim 9, further comprising defining the plurality of batch job categories.

12. A method as in claim 9, further comprising assigning one or more time slots for each of the plurality of batch job categories.

13. A method as in claim 9, wherein the time slots are recurring.

14. A method as in claim 9, further comprising monitoring load on a system during one or more of the time slots.

15. A method as in claim 14, wherein the processing processes each batch job during one or more of the selected time slots in which the monitored load below a predetermined threshold.

16. A method as in claim 9, further comprising prioritizing the batch jobs according to predetermined criteria.

17. An apparatus comprising:
a reception unit to receive an inquiry to initiate a batch job associated with one of a plurality of batch job categories;
a presentation unit to present a plurality of available time slots in which the batch job can be processed, each of the plurality of available time slots being associated with the one of a plurality of batch job categories;
a selection unit to select one or more time slots from the plurality of available time slots; and
a generation unit to generate a request to initiate the batch job within one of the selected time slots.

18. An apparatus as in claim 17, further comprising:
a receiver to receive the request for a batch job; and
a processor to process the batch job during one or more of the selected time slots.

19. An apparatus as in claim 17, further comprising:
receiving means to receive a plurality of requests for batch jobs; and
processing means for processing each batch job during one or more of the selected time slots.

20. An apparatus as in claim 17, wherein the presentation unit includes a graphical user interface to present the plurality of available time slots.
